(19) United States
(12) Patent Application Publication
(10) Pub. No.: US 2020/0320553 A1
(43) Pub. Date: Oct. 8, 2020

(54) PRODUCT-STATE PREDICTION BASED ON WEBSITE INTERACTIONS

(71) Applicant: AutoScores S.L., Madrid (ES)

(72) Inventors: Noah John, Orlando, FL (US); David Pilo, Orlando, FL (US)

(21) Appl. No.: 16/377,022

(22) Filed: Apr. 5, 2019

(51) Int. Cl. G06Q 30/02; G06N 20/00

(52) U.S. Cl. CPC G06Q 30/0202; G06N 20/00; G06Q 30/0204

(57) ABSTRACT

According to an aspect of an embodiment, a method may include obtaining first interactions with a website associated with a first product listed for sale on the website. The method may also include grouping, into a first data set and a second data set, the first interactions according to when the first product enters a second state of a multi-state progression of being sold. The method may also include training a machine-learning model using the first data set and the second data set. The method may also include obtaining second interactions associated with a second product. The method may also include obtaining a confidence of an expected state of the second product in the multi-state progression by using the second interactions with the machine-learning model. The method may also include predicting a likelihood that the second product enters the expected state within a particular period of time.

### FIELD

The embodiments discussed in the present disclosure are related to product-state prediction based on website interactions.

### BACKGROUND

A product may be listed for sale on a website. Users may interact with the website to obtain information about the product. For example, a car dealer may list cars for sale on a website. For each car the dealer has available for sale, the website may include a webpage listing the car for sale and providing information about the car. A user may use the website to obtain information about cars that interest the user.

The subject matter described in the present disclosure is not limited to embodiments that solve any disadvantages or that operate only in environments such as those described above. Rather, this background is only provided to illustrate one example technology area where some embodiments described in the present disclosure may be practiced.

### SUMMARY

One embodiment of the present disclosure may include a method that includes obtaining first interactions with the website that are performed by a first plurality of devices that access the website. The first interactions may be associated with a first product listed for sale on the website. The method may also include grouping, into a first data set, the first interactions that occur during a first time period while the first product is in a first state of a multi-state progression of being sold. The method may also include grouping, into a second data set, the first interactions that occur during a second time period that ends when the first product enters a second state of the multi-state progression of being sold. The method may also include training a machine-learning model using the first data set and the second data set. The method may also include obtaining second interactions with the website that are performed by a second plurality of devices that access the website. The second interactions may be associated with a second product. The method may also include obtaining a confidence of an expected state of the second product in the multi-state progression of being sold by using the second interactions with the machine-learning model. The method may also include predicting, based on the confidence of the expected state of the second product, a likelihood that the second product enters the expected state within a particular period of time.

One or more of the objects and/or advantages of the embodiments will be realized or achieved at least by the elements, features, and combinations particularly pointed out in the claims.

It is to be understood that both the foregoing general description and the following detailed description are given as examples, and are explanatory and are not restrictive of the present disclosure, as claimed.

### BRIEF DESCRIPTION OF THE DRAWINGS

Example embodiments will be described and explained with additional specificity and detail through the use of the accompanying drawings in which:

FIG. 1 is a block diagram of an example environment that predicts a change in the sales state of a product based on interaction data;

FIG. 2 is a block diagram of another example environment that predicts a change in the sales state of a product based on interaction data;

FIG. 3 is a block diagram of an example webpage and example feature set derived from the example webpage;

FIG. 4 is a block diagram of an example webpage that includes information about multiple products;

FIG. 5 is a graph illustrating an example of a correlation between a confidence of an expected sales state of a product and a sales state change of the product;

FIG. 6 is a flow chart of an example method to predict a change in the sales state of a product based on interaction data; and

FIG. 7 is a block diagram of an example computing system,

all according to at least one embodiment described in the present disclosure.

### DESCRIPTION OF EMBODIMENTS

A product may be listed for sale on a webpage of a website. The webpage may include elements that may provide information about the product including images of the product and/or text describing the product. The webpage may also include elements with which a user of the webpage may interact, for example, images that may be enlarged, “like,” “print,” and/or “email link” buttons, and/or form fields. Multiple users may interact with the webpage to learn information about the product. How the users interact with the webpage may provide information about user interest in the product. For example, multiple users viewing multiple photos of the product may indicate a higher user interest.

The present disclosure may describe methods and systems that may be configured to predict the sale of current products based on how users interact with listings of the current products on a website. To predict the sales, interaction data indicating how users interact with the website may be obtained. The interaction data may indicate how users have interacted with the website with respect to multiple products listed for sale on the website, including the current products. In some embodiments, the interaction data may describe how users have interacted with the web site with respect to multiple products that have been sold. The interaction data related to the products that have been sold may be used as training data to train a machine-learning model. Interaction data related to the current products may be applied to the machine-learning model. The machine learning model may output a confidence that may indicate how similar user interactions on the website with respect to the current products are to user interactions with products that have been sold on the website. Based on the confidence, a prediction may be made relative to whether the current products may sell within a period of time.

In some embodiments, a sale of the products listed on the web site may include a multi-state progression. For example, if the product is a house, the sale of the house may include the states of “for sale,” “offer received,” “under contract,” “financing,” and “sold,” among others. In these or other embodiments, the interaction data may include state data relating to the state of the products listed for sale. The interaction data may be applied to the machine-learning model. The machine learning model may output a confidence that may indicate how similar the interactions with a webpage listing the product are to interactions with other webpages listing other products that have entered a particular state. For example, the confidence may be relative to a similarity between interactions of a particular webpage listing a particular house and interactions with other webpages listing other houses that have entered the state “under contract.” Based on the confidence, a prediction may be made relative to whether the particular product may enter a particular state of the multi-state progression within a period of time. For example, the prediction may be relative to whether the particular product enters the state of “offer received” within a period of time.

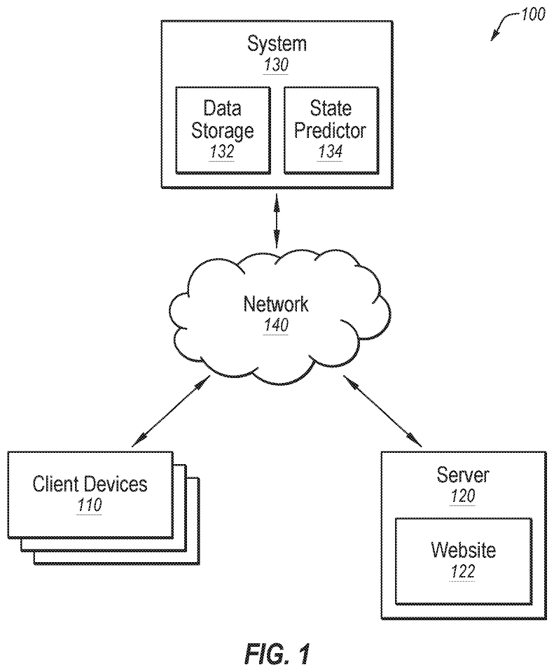

FIG. 1 is a block diagram of an example environment 100 that predicts a change in the sales state of a product based on interaction data according to at least one embodiment described in the present disclosure. The environment 100 may include client devices 110, a server 120 which may host a website 122, a system 130 which may include a data storage 132 and a state predictor 134, and a network 140.

In some embodiments, the network 140 may include hardware and software configured to communicatively couple computing systems. The network 140 may include any suitable hardware and software for communicatively coupling computing systems, for example, a local area network (LAN), a wide area network (WAN), a cellular radio frequency (RF) network, and/or the Internet. The network 140 may communicatively couple the server 120 with the client devices 110. Alternately or additionally, the network 140 may communicatively couple the client devices 110 with the system 130. Alternately or additionally, the network 140 may communicatively couple the server 120 with the system 130.

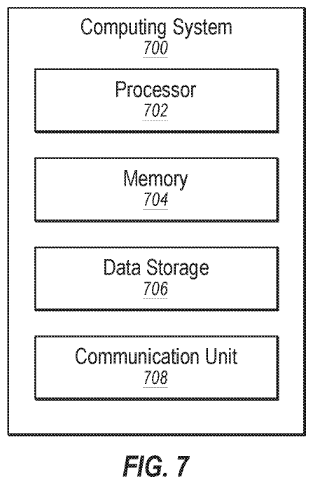

In some embodiments, the server 120 may include a computing system that may host a website. The server 120 may include any suitable computing system for hosting a website, for example a web server. The computing system 700 of FIG. 7 may be an example implementation of the server 120.

In some embodiments, the server 120 may store instructions and/or elements of webpages of the website 122. The server 120 may be configured to make the instructions and/or elements available to be accessed and/or downloaded over the network 140 by other devices, such as the client devices 110.

In some embodiments, the website 122 may include a logical location accessible on the network 140 (for example, described by an internet protocol (IP) address). The location may include code representing multiple webpages. The code may include instructions for a client device to present the webpages. The website 122 may be accessible by client devices 110 through the network 140.

In some embodiments, the website 122 may list the multiple products for sale. For example, the website 122 may include multiple webpages including product detail webpages. Each of the product detail pages may provide information about a product for sale. Additionally or alternatively, the website 122 may include multi-product webpages that provide information about multiple products. For example, a search results webpage may be configured to present information regarding multiple products on the same webpage. In this and other embodiments, the search results webpage may include a selectable link. Selection of the link may result in the navigation and presentation of a product detail webpage that provides more information about a particular product.

The webpages may or may not facilitate the user to purchase the product through the webpages. For example, the webpages may include an option for the user to bid on the product, or make an offer to purchase the product, for example, through an online auction. Alternatively, the webpages may provide information about the product without enabling the user to negotiate for or purchase the product.

In some embodiments, the client devices 110 may include a computing system through which a user may interact with a website. The client devices 110 may include any suitable computing system for interacting with a website, for example, a personal computer, a laptop, a tablet, or a smart phone. The computing system 700 of FIG. 7 may be an example of one of the client devices 110.

In some embodiments, the client devices 110 may be configured to access the webpages of the website 122 over the network 140. For example, the client devices 110 may download the webpages over the network 140. The client devices 110 may render the downloaded webpages for presentation to users of the client devices 110. The client devices 110 may obtain input from the user with respect to the rendered webpages. For example, a user interface may obtain input from a user to select images, text, links, and/or other selectable elements on the webpage, scroll through a webpage, spend time on the webpage, move a cursor relative to the webpage and/or elements on the webpage, enter information on the webpage, or otherwise interact with the webpage. The input obtained by the client devices 110 from the users with respect to the webpages may be referred to as user interactions with the webpages. In some embodiments, the webpage may include instructions that cause the client devices 110 to record interaction data regarding the interactions of the users with the webpages. The client devices 110 may be configured to communicate the interaction data to the system 130 through the network 140.

In some embodiments, the system 130 may obtain the interaction data from the client devices 110 and/or state data of the products listed for sale on the website 122. The system 130 may be configured to perform one or more operations to predict a change in the state of a product based on the interaction data. The system 130 may include any suitable computing system, for example, a computing server. The computing system 700 of FIG. 7 may be an example implementation of the system 130.

In some embodiments, the data storage 132 may include one or more devices configured to store interaction data and/or the state data. The data storage 706 of FIG. 7 may be an example of the data storage 132.

The state predictor 134 may be configured to access the interaction data and/or the state data stored by the data storage 132. Additionally or alternatively, the state predictor 134 may obtain the interaction data and/or the state data.

Additionally or alternatively, the state predictor 134 may be configured to obtain the state data of products listed for sale on the website 122. For example, in some embodiments, the state predictor 134 may be configured to crawl the website 122 to obtain the state data. Alternatively or additionally, the state predictor 134 may obtain the state data through an Application Programming Interface (API). For example, a vendor of the products may submit the state data according to the API. The state data may indicate when the products changed states, and/or durations of time during which the products were in the various states. For example, the state data may include data for a particular product indicating that the particular product was in the first state from January 1 until January 31, and the second state from February 1 until February 28.

The state predictor 134 may be configured to train a machine-learning model using the interaction data and the state data. The machine-learning model may be configured to categorize products based on the interaction data associated with the products. For example, the machine-learning model may be configured to categorize products according to the state of the products in a multi-state progression of being sold.

In some embodiments, the interaction data may be associated with products listed for sale on the webpages of the website 122. For example, particular interactions relative to a product detail page of a particular product may be associated with the particular product. Further, interactions relative to a multi-product page may be categorized and associated with the multiple products of the multi-product page.

In some embodiments, the state predictor 134 may be configured to associate interaction data with states of products. For example, based on the state data of a particular product, interactions associated with the particular product may be associated with the final state of the particular product. Additionally or alternatively, interaction data may be associated with states based on a window of time that precedes a state change. For example, all interactions with a particular product that occurred three days before the product entered the second state may be associated with the second state. The windows of time and states that define the associations can be variously adjusted or defined according to a purpose of the categorizations and predictions of the machine-learning model. For example, for a particular purpose it may be useful to associate only the interactions that occurred the day a product entered the second state with the second state and all previous interactions with the first state.

In some embodiments, the state predictor 134 may be configured to categorize the interaction data according to a state of the product associated with the interactions. For example, interaction data of a product may be categorized into data sets according to associations of the interaction data with different states of a multi-state progression of the product being sold. For example, the first data set may include interaction data that is associated with a state of the product being “for sale.” The second data set may include interaction data that is associated with a state of the product being “under contract.”

In some embodiments, the state predictor 134 may be configured to use the categorized interaction data to train a machine-learning model. The machine-learning model may be any suitable machine-learning model, for example, a support vector machine or a neural network. The machine-learning model may be trained with multiple, for example, tens, hundreds, or thousands, of sets of categorized interaction data. For example, the interaction data associated with thousands of products may be used to train the machine-learning model.

In some embodiments, after the training of the machine-learning model, the state predictor 134 may be configured to apply additional interaction data to the machine learning model. The additional interaction data may include interaction data that may or may not be used to train the machine-learning model. In these and other embodiments, the additional interaction data may be associated with a product offered for sale on the website and the interaction data used to train the machine-learning model may be associated with other products that have been sold.

The machine-learning model may be used to classify additional interaction data into one of the different categories of the interaction data used in training the machine-learning model. For example, the machine-learning model may classify the additional interaction data as being in the “sold” category. The machine-learning model classifying the additional interaction data into a category indicates that the additional interaction data is more similar to interaction data of the category than to interaction data of another category. The machine-learning model may also output a confidence score with respect to the classification. The confidence score may quantify the likelihood that the machine-learning model accurately classified the additional interaction data. Thus, the machine-learning model may provide confidences of expected states of products by using the additional interaction data with the machine-learning model.

In some embodiments, the categories of the interaction data may relate to the categories into which the machine-learning model may categorize additional interaction data. For example, if the interaction data is categorized into one of three categories according to the state of the sale of the product, the machine-learning model may be able to classify additional interaction data into one of the three categories.

In some embodiment, the state predictor 134 may also be configured to predict a likelihood that a first product associated with the additional interaction data enters a particular state within a period of time. In these and other embodiments, to predict the likelihood the state predictor 134 may determine a correlation between confidences of products and state data of products. To determine the correlation, the state predictor 134 may obtain confidences of multiple second products. The multiple second products may be associated with second interaction data. In some embodiments, the second interaction data may be included in or may be different from the interaction data used to train the machine-learning model.

In some embodiments, the confidences of second products may be obtained by using the interaction data associated with the second products with the machine-learning model. Multiple confidences for each of the second products may be obtained. One or more of the confidences for each of the second products may be related to different states of the multi-state progression of being sold. For example, for a first one of the second products, a first confidence may be obtained for a first state and a second confidence may be obtained for a second state.

The confidences of the second products may be correlated with state data of the second products that indicates the duration of time that the second products were in the various states of the multi-state progression of being sold. For example, the particular one of the second products may have been classified in the third state and given a confidence of 0.9. The state data may indicate that the particular one of the second products remained in the second state for four days prior to entering the third state when the particular one of the second products had the confidence of 0.9 with respect to the third state. In this instance, a correlation may be determined that a product in a second state with a confidence of 0.9 may enter a third state from the second state within four days or some longer time period, such as a week. As described, the state predictor 134 may use the confidences and the state data of the second products to determine a correlation generally between confidence scores of products and a time that the products may be in each state of the multi-state progression of being sold. Alternatively or additionally, the state predictor 134 may use the confidences and the state data of the second products to determine a correlation generally between confidence scores of products and a time remaining before the products move to the next state in the multi-state progression of being sold.

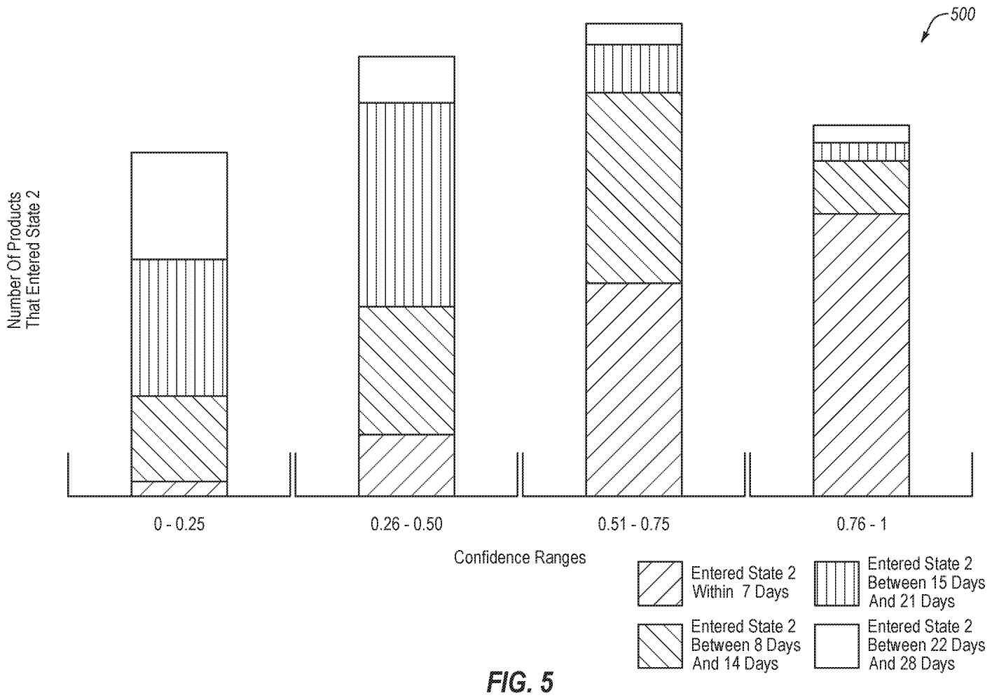

Using the correlation between confidences and state data, the state predictor 134 may predict a likelihood that the first product enters a particular state within a period of time based on a confidence of the first product with respect to the particular state. For example, a first product may be classified in a third state with a confidence of 0.9. The state predictor 134 may determine, based on the correlation between confidences and state data, that eight out of ten products in a second state with a confidence of 0.9 enter the third state within one week. As such, the state predictor 134 may be configured to predict a likelihood that the first product may enter the third state within a week as eighty percent. A further example of a correlation between confidences and state changes is provided below with regard to FIG. 5.

Modifications, additions, or omissions may be made to the environment 100 without departing from the scope of the present disclosure. For example, in some embodiments the state predictor 134 and/or the data storage 132 may be distributed across multiple computing systems and/or in multiple locations. For another example, the client devices 110 may perform one or more operations to predict a change in the state of a product based on interaction data. For example, the client devices 110 may perform one or more operations associated with categorizing the interaction data before communicating the interaction data to the system 130.

Additionally or alternatively, some or all of the interaction data may be relative to an application that lists products for sale. For example, the server 120 may provide (e.g. through an API) information, for example, images and/or text, relative to a product listed for sale to the client devices 110 through an application on the client devices 110. The application may present multiple screens or views which may be analogous to the webpages described above. For example, the application may present a product detail screen which may provide information relative to a product listed for sale. The product detail screen may be analogous to a product detail page described above. There may be interactions that may occur relative to the product detail screen which may be analogous to the interactions described above, for example, viewing images, reading a text description or clicking a “like” button. The application, in conjunction with the client devices 110, may be configured to track the interactions and communicate the interactions to the system 130.

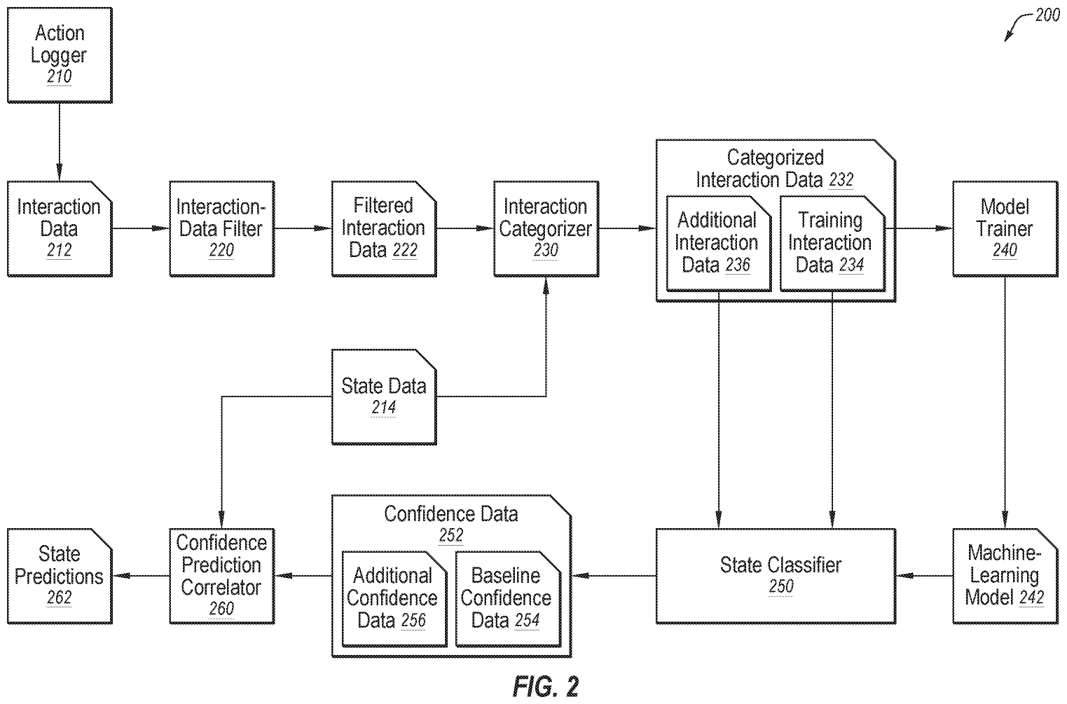

FIG. 2 is a block diagram of another example environment 200 that predicts a change in the sales state of a product based on interaction data, according to at least one embodiment described in the present disclosure. The environment 200 may include an action logger 210, an interaction-data filter 220, an interaction categorizer 230, a model trainer 240, a state classifier 250, and a confidence prediction correlator 260.

In some embodiments, in general, the action logger 210 may record interactions of users with a website and generate interaction data 212. The interaction-data filter 220 may filter the interaction data 212 to produce filtered interaction data 222. The interaction categorizer 230 may categorize the filtered interaction data 222 to produce categorized interaction data 232. One or more of the categories of the categorized interaction data 232 may be based on states indicated in state data 214. The categorized interaction data 232 may include training interaction data 234 and additional interaction data 236.

The model trainer 240 may use the training interaction data 234 to generate a machine-learning model 242. The state classifier 250 may apply the additional interaction data 236 to the machine-learning model 242 to produce additional confidence data 256, which may be included in confidence data 252. The state classifier 250 may obtain baseline confidence data 254 which may be included in the confidence data 252. The confidence prediction correlator 260 may correlate the baseline confidence data 254 and the state data 214 and use the correlation with the additional confidence data 256 to produce state predictions 262.

In some embodiments, the action logger 210 may be configured to record interactions of users of a website. The action logger 210 may be implemented as a script (for example a JavaScript script) that may be run on the client devices 110 of FIG. 1 as part of, or concurrently with, the rendering of a webpage. For example, the action logger 210 may be downloaded from the server 120 of FIG. 1 with one or more webpages of the website 122 of FIG. 1 or the action logger 210 may be downloaded from another server. Thereafter the action logger 210 may be run on the client devices 110.

In some embodiments, the interaction data 212 may include data regarding interactions of users with a website. The interactions of the interaction data 212 may be associated with one or more webpages of the web site. The interaction data 212 may include such information as: time spent on a webpage, time spent viewing a portion of the webpage, time spent using an input device while viewing a webpage, mouse movements on the webpage, mouse movements relative to one or more elements on the webpage, clicks on photos or text of the webpage, clicks on the navigation toolbar, Hypertext Markup Language (HTML) form interactions, clicks on exit links, clicks on modals, clicks on interactive text, cursor positions, mouse-over interactions, and/or screenshot captures. Also, the interaction data 212 may include meta-data, for example a timestamp and a Universal Resource Locator (URL) associated with the interactions.

In some embodiments, the state data 214 may include data relative to the states of products in the multi-state progression of being sold. For example, the state data 214 for a particular product may include information regarding whether that particular product was “for sale,” “for lease,” or “under contract.” including dates or durations of time during which the particular product was in the state. In some embodiments, the state data 214 may be obtained by crawling a website, for example, the website 122 of FIG. 1. Alternatively or additionally, the state data 214 may be supplied through another interface, for example, an API.

In some embodiments, the interaction-data filter 220 may be configured to filter the interaction data 212 by removing some of the interactions. For example, the interaction-data filter 220 may filter out irrelevant interactions, for example, clicks or mouse movements that do not relate to any product on a particular webpage. In some embodiments, the interaction-data filter 220 may be implemented on the client devices 110 of FIG. 1. For example, the interaction-data filter 220 may be downloaded from the server 120 of FIG. 1 with the webpages of the web site 122 of FIG. 1. Thereafter the interaction-data filter 220 may be run on the client devices 110. Additionally or alternatively, the interaction-data filter 220 may be implemented by the system 130 of FIG. 1.

In some embodiments, the filtered interaction data 222 may include a subset of the interaction data 212 after some of the interactions have been removed by the interaction-data filter 220.

In some embodiments, the interaction categorizer 230 may be configured to categorize the filtered interaction data 222 according to one or more categories to generate the categorized interaction data 232. The interaction categorizer 230 may categorize the filtered interaction data 222 according to two or more different types of categories. For example, the interaction categorizer 230 may be configured to categorize the filtered interaction data 222 according to: product, time, state, and/or classes of interaction. Thus, a single interaction may be categorized according to a product to which the interaction relates, the time the interaction took place, a state of the product at the time of the interaction, and a class of the interaction.

In some embodiments, one or more operations associated with the interaction categorizer 230 may be implemented by the client devices 110 of FIG. 1. Additionally or alternatively, one or more of operations associated with the interaction categorizer 230 may be implemented by the system 130 of FIG. 1. For example, at the client devices 110, the filtered interaction data 222 may be categorized according to product, for example based on the URLs. The filtered interaction data 222 may be further categorized at the system 130 according to classes of interaction.

For example, the interaction categorizer 230 may be configured to categorize the filtered interaction data 222 according to products, such that interactions that pertain to a particular product are categorized according to the particular product. The categorizing may include associating the interactions with the products to which the interactions pertain. Other operations described with respect to the environment 200 may use the associations between products and interactions. For example, the confidence prediction correlator 260 may use the association between the products and the interactions when correlating confidences of the confidence data 252 with states of the state data 214.

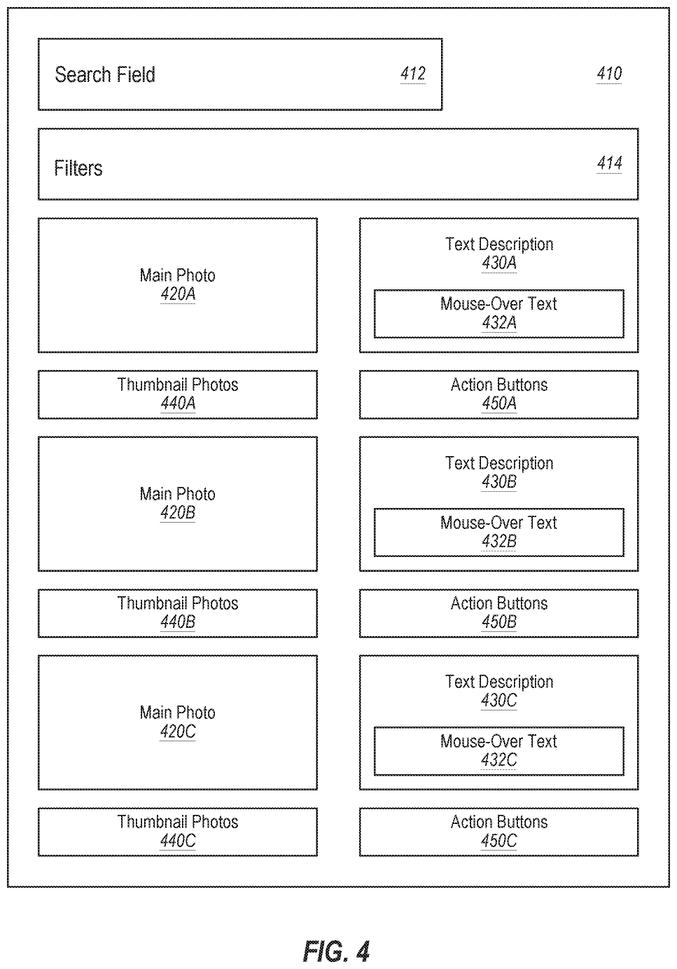

In some embodiments, a webpage may include information about a single product. In these embodiments, the interaction categorizer 230 may be configured to associate all interactions with the webpage with the single product. In some embodiments, a multi-product webpage may include information about multiple products. In these embodiments, the interaction categorizer 230 may be configured to associate interactions with products based on a determination of to which products the interactions relate. Additional detail regarding the association of interactions with products is given below with respect to FIG. 4.

As another example, the interaction categorizer 230 may be configured to categorize the filtered interaction data 222 according to time, such that interactions may be categorized according to which calendar date, or time of day the interactions occur. The categorization of the filtered interaction data 222 based on time may be based on the meta-data which may include a timestamp for each interaction.

As another example, the interaction categorizer 230 may be configured to categorize the filtered interaction data 222 according to a state of the products. For example, interactions may be categorized according to a final state of the products with which they are associated. As another example, interactions with a webpage associated with a product that occur while the product is in the first state are part of a first category and interactions with the webpage that occur while the product is in a second state are part of a second category. Additionally or alternatively, the interaction categorizer 230 may be configured to categorize the filtered interaction data 222 according to time and state. For example, there may be a category for interactions that occurred within three days of a change from a first state to the second state.

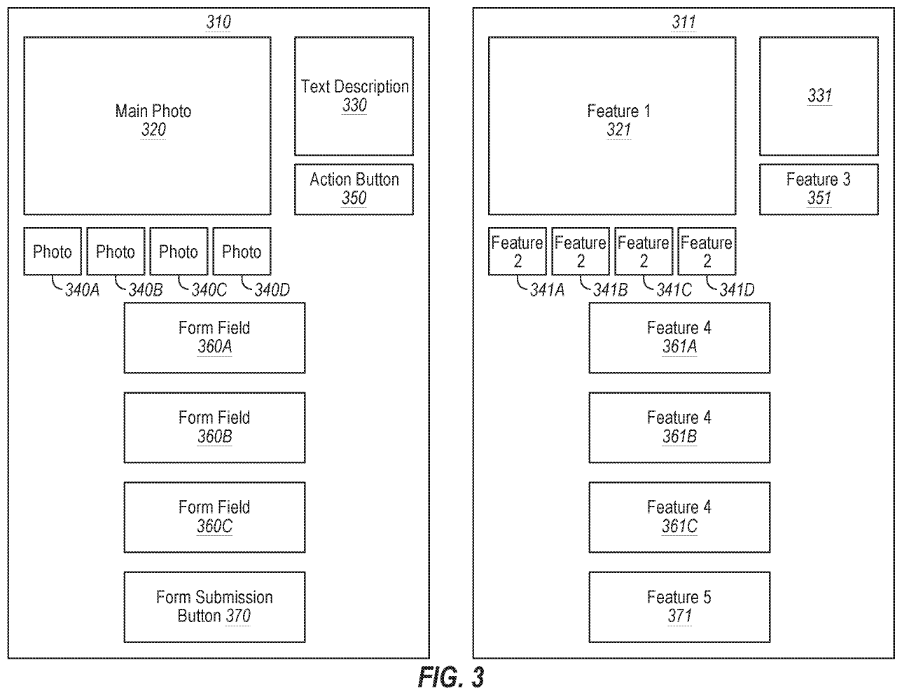

As another example, the interaction categorizer 230 may be configured to categorize the filtered interaction data 222 according to classes of interactions such that different classes of actions are in different categories. For example, different categories may include clicks on photos, selection of text, clicks of a particular button, and durations of time spent on a webpage. Additional details regarding the categorization of interactions based on classes of interaction are given below with respect to FIG. 3.

In some embodiments, the different categories may be layered such that a category has multiple conditions. For example, a category may be “clicks on a print button in the morning.”

In some embodiments, the categorized interaction data 232 may include the filtered interaction data 222 after the filtered interaction data 222 has been categorized. The categorized interaction data 232 may be organized according to the categorization or the categorized interaction data 232 may include additional data indicating the categories.

In some embodiments, the categorized interaction data 232 may include the training interaction data 234 and the additional interaction data 236. The training interaction data 234 may be a subset of the categorized interaction data 232 which may be used to train the model trainer 240. In some embodiments, the training interaction data 234 may include interaction data relative to products that have entered a particular state in the multi-state progression of being sold. For example, the training interaction data 234 may include interaction data relative to products that are “under contract.” In contrast, the additional interaction data 236 may include interaction data relative to products that have not entered the particular state. For example, the additional interaction data 236 may include interactions relative to products that are “for sale.”

In some embodiments, the model trainer 240 may be configured to use the training interaction data 234 to train a machine-learning model 242. The categories of the categorized interaction data 232 may be used as features of the training data that are used to train the machine-learning model 242. For example, features of the training data used to train the machine-learning model 242 may include “number of clicks on product photos in the past three days,” “clicks on navigation links in the past seven days,” “form submissions in the past two days,” and/or a state.

In some embodiments, the model trainer 240 may train the machine-learning model 242 according to any suitable method. The model trainer 240 may include supervised or unsupervised training. In some embodiments, the machine-learning model 242 may include any suitable machine-learning model, for example, a supportvector machine or a neural network.

In some embodiments, the machine-learning model 242 may be trained with respect to the states of products to classify interaction data into expected states. For example, the machine-learning model 242 may be trained to classify additional interaction data 236 into states based on whether the additional interaction data 236 is similar to training interaction data 234 associated with a first state, a second state, or a third state.

In some embodiments, the state classifier 250 may be configured to apply additional interaction data 236 to the machine-learning model 242 to classify the additional interaction data 236 into expected states of the multi-state progression of being sold. In addition to classifying the additional interaction data 236, the state classifier 250 may be configured to generate a confidence relative to the classifications. The confidence may indicate a degree of similarity between the additional interaction data 236 and the training interaction data 234 associated with a particular state. For example, if there is a high degree of similarity between interactions associated with a webpage and a product listed for sale on the webpage and the interactions associated with products categorized with the particular state that were used to train the machine-learning model 242, the product may be classified with the particular state and may be given a high confidence.

In some embodiments, the state classifier 250 may be configured to generate confidence data 252 including the classifications and the confidences. The confidence data 252 may include the additional confidence data 256 which may include classifications and confidences related to the additional interaction data 236.

In some embodiments, the confidence data 252 may include the baseline confidence data 254, which may include classifications and confidences of other products i.e. the baseline confidence data 254 may be associated products that are not associated with the additional confidence data 256 and the additional interaction data 236.

In some embodiments, the state classifier 250 may be configured to apply the training interaction data 234 to the machine-learning model 242 to generate classifications and confidences relative to the training interaction data 234. The classifications and confidences relative to the training interaction data 234 may be included in the baseline confidence data 254.

In these or other embodiments, the state classifier 250 may be configured to obtain the classifications and confidences from another source. For example, the baseline confidence data 254 may be based on products that were listed for sale on the website a year ago, or the baseline confidence data 254 may be based on classifications and confidences generated relative to another website.

As an example of a source on which the baseline confidence data 254 may be based, a website may list multiple products for sale. On a regular basis, the multiple products may be classified and confidences may be generated relative to the classifications. For example, on a daily basis, a classification and confidence relative to the classification may be generated based on interactions that occur with a product on a website. The classifications and confidences may be recorded over a period of time. On any given day, the baseline confidence data 254 may be polled from the recorded classifications and confidences by associating the classifications and confidences with states (e.g. from the state data).

As a more specific example, a website may list multiple products for sale. The website may track interactions with webpages associated with the multiple products. A classification and confidence relative to the classification may be generated for each product each day based on the tracked interactions. As products transition states, the transitioned products may be removed from being listed for sale on the website. Classification and confidence data relative to removed products may be retained. On a given day, the classification and confidence data may be polled, for example, to associate classifications and confidences with state data. For example, on the given day, the classification and confidence data may be polled to determine a number of products that were classified in a second state with a confidence of 0.75 or greater two weeks ago that entered the second state within the intervening two weeks. As another example, the classification and confidence data may be polled to determine a percentage of products that were ever classified in the second state with a confidence of 0.75 or greater that entered the second state within two weeks from the date the products were first classified in the second state with a confidence of 0.75 or greater. As the products are sold and removed from being listed for sale on the website, the interaction data relative to the products may or may not be included in the training interaction data 234. Thus, the baseline confidence data 254 may or may not be based, in whole or in part, on the training interaction data 234.

In some embodiments, the confidence prediction correlator 260 may be configured to predict whether one or more products enters a particular state within a particular period of time based on the confidence of the one or more products with respect to the particular state. For example, the confidence prediction correlator 260 may be configured to correlate the state data 214 of products with the baseline confidence data 254 of the products. The correlation may indicate a time that products may remain in each state of a multi-state progression of being sold based on the confidence scores of the products. As an example, the correlation may indicate that seventy-five percent of products classified in the second state, and given a confidence of 0.75 or higher remained in the first state for less than a week.

In some embodiments, the confidence prediction correlator 260 may be configured to correlate the additional confidence data 256 with baseline confidence data 254, and make a prediction based on the additional confidence data 256 and the correlation between the baseline confidence data 254 and the state data 214. To continue the example above, the additional confidence data 256 may include a classification of a product in the second state, with a confidence score of 0.9. Given the confidence score of 0.9, the confidence prediction correlator 260 may be configured to predict with 75 percent confidence that the product enters the second state within a week.

In some embodiments, the state predictions 262 may include likelihoods whether particular products enters a particular state within a particular period of time.

Modifications, additions, or omissions may be made to the environment 200 without departing from the scope of the present disclosure. For example, in some embodiments the interaction-data filter 220 may be omitted. Further, the order of operations may vary according to different implementations.

FIG. 3 is a block diagram of an example webpage 310 and example feature set 311 derived from the example webpage according to at least one embodiment described in the present disclosure. The elements and format of the webpage 310 and the corresponding feature set 311 are given as an example. The systems and methods of the present disclosure may be implemented on any suitable webpage or user interface including any elements.

As an example, the webpage 310 may include a main photo 320, a text description 330, four photos 340, an action button 350, three form fields 360, and a form submission button 370. Four photos are illustrated in FIG. 3: a first photo 340A, a second photo 340B, a third photo 340C, and a fourth photo 340D, (collectively referred to as the photos 340 and/or individually referred to as the photo 340). Three form fields are illustrated in FIG. 3: a first form field 360A, a second form field 360B, and a third form field 360C, (collectively referred to as the form fields 360 and/or individually referred to as the form field 360). The number of main photos 320, text descriptions 330, photos 340, action buttons 350, form fields 360, and form submission buttons 370 may vary according to different implementations. Further, the webpage 310 may include additional elements not shown in FIG. 3.

The features of the feature set 311 may correspond to the elements of the webpage 310. Thus, the feature set 311 may include a primary feature 321 (corresponding to the main photo 320), a non-feature 331 (corresponding to the text description 330), four secondary features 341 (corresponding to the four photos 340), a tertiary feature 351 (corresponding to the action button 350), three quaternary features 361 (corresponding to the three form fields 360), and a quinary feature 371 (corresponding to the form submission button 370). Corresponding to the four photos 340, four secondary features are illustrated in FIG. 3: a first secondary feature 341A, a second secondary feature 341B, a third secondary feature 341C, and a fourth secondary feature 341D, (collectively referred to as the secondary features 341 and/or individually referred to as the individual feature 341). Corresponding to the three form fields 360, three quaternary features are illustrated in FIG. 3: a first quaternary feature 361A, a second quaternary feature 361B, and a third quaternary feature 361C, (collectively referred to as the quaternary features 361 and/or individually referred to as the quaternary feature 361).

As described above with regard to the interaction categorizer 230 of FIG. 2, interaction data may be categorized according to a classes of interactions. The elements of the webpage 310, and the features of the feature set 311 may illustrate an example of how interactions may be categorized according to classes of interactions. As described above, the categories may be relevant to the training of the machine-learning model. For example, the classes of interactions may be a feature of the training data for the machine-learning model. For example, a feature of the training data used to train the machine-learning model may include “number of clicks on a thumbnail photo” or “number of completed form submissions”

In some embodiments, similar elements may be categorized in the same category. Similar elements may be categorized in the same category because the similar elements may provide similar information relative to the classifications of the machine-learning model. For example, from the perspective of the classifications of a product as “for sale” vs. “sold,” there may not be a relevant difference between a click on the first photo 340A and the third photo 340C. In contrast, from the perspective of the classification of the product as “for sale” vs. “sold,” there may be a relevant difference between a click on the main photo 320 and a click on the form submission button 370.

The designation of the non-feature 331 as a “non-feature” is intended to illustrate that some interactions with an element of the webpage 310 may not be relevant to the classification of products by the machine-learning model, thus, some elements of the webpage 310 may not be categorized as features, or categorized as “non-features.”

In some embodiments, the features of the feature set 311 may be identified by analyzing the HTML or Cascading Style Sheet (CSS) of the webpage 310. For example, styles elements, as found in the CSS, may be compared to identify elements that are related to the same features. As another example, HTML tags of the webpage 310 may be parsed to generate the feature set 311. In further detail, HTML tags may be compared to a common HTML pattern to determine how to correlate the elements with separate features. As another example, the HTML code may be parsed and elements may be categorized according to similarities between the elements of the HTML code. For example, the main photo 320 and the photos 340 may have a common HTML tag but different size parameters. Thus, the photos 340 may be categorized together, based on a common tag and common attributes, while the main photo 320 may be categorized apart from the photos 340 based on the HTML code of the main photo 320 having different parameters.

Modifications, additions, or omissions may be made to the webpage 310 and/or the feature set 311 without departing from the scope of the present disclosure.

FIG. 4 is a block diagram of an example webpage 410 that includes information about multiple products according to at least one embodiment described in the present disclosure. The elements and format of the webpage 410 are given as an example. The webpage 410 is illustrated and described as a search results page for illustration purposes. The systems and methods of the present disclosure may be implemented on any suitable webpage or information page including information about multiple products, for example, a home page or a featured products page.

As an example, the webpage 410 may include a search field 412, filters 414, and one or more search results. Each of the search results may include a main photo 420, a text description 430 including mouse-over text 432, one or more thumbnail photos 440, and one or more action buttons 450. Three search results are illustrated in FIG. 4. The three search results include a first main photo 420A, a second main photo 420B, and a third main photo 420C, respectively, (collectively referred to as the main photos 420 and/or individually as the main photo 420). The three search results also include a first text description 430A, a second text description 430B, and a third text description 430C, respectively, (collectively referred to as the text descriptions 430 and/or individually as the text description 430). The three search results also include a first mouse-over text 432A, a second mouse-over text 432B, and a third mouse-over text 432C, respectively, (collectively referred to as the mouse-over texts 432 and/or individually as the mouse-over text 432). The three search results also include a first thumbnail photos 440A, a second thumbnail photos 440B, and a third thumbnail photos 440C, respectively, (collectively referred to as the thumbnail photos 440 and/or individually as the thumbnail photos 440)s. The three search results also include a first action buttons 450A, second action buttons 450B, and third action buttons 450C, respectively, (collectively referred to as the action buttons 450 and/or individually as the action buttons 450). The number of search results, main photos 420, text descriptions 430, thumbnail photos 440, and action buttons 450 may vary according to different implementations. Further, the webpage 410 may include additional elements not shown in FIG. 4.

The webpage 410 of FIG. 4 illustrates one way of conceptualizing a multi-product webpage or presentation page. As described above, systems and methods of the present disclosure may allocate interactions taken with respect to a multi-product webpage with the individual products of the webpage. The webpage 410 of FIG. 4 is given as an example multi-product webpage or presentation page as a context for a description of how associating interactions with individual products may occur.

As an example, each of the first main photo 420A, the first text description 430A, the first mouse-over text 432A, the first thumbnail photos 440A, and the first action buttons 450A may pertain to a first product or provide information regarding the first product. Likewise, each of the second main photo 420B, the second text description 430B, the second mouse-over text 432B, the second thumbnail photos 440B, and the second action buttons 450B may pertain to or provide information about a second product. And each of the third main photo 420C, the third text description 430C, the third mouse-over text 432C, the third thumbnail photos 440C, and the third action buttons 450C may pertain to or provide information about a third product. Interactions relating to the first main photo 420A, the first text description 430A, the first mouse-over text 432A, the first thumbnail photos 440A, and the first action buttons 450A may be associated with the first product. Interactions relating to the second main photo 420B, the second text description 430B, the second mouse-over text 432B, the second thumbnail photos 440B, and the second action buttons 450B may be associated with the second product. And, interactions relating to the third main photo 420C, the third text description 430C, the third mouse-over text 432C, the third thumbnail photos 440C, and the third action buttons 450C may be associated with the third product.

In some embodiments, the systems and methods of the present disclosure may include associating the various interactions with the appropriate product. For example, the systems and methods of the present disclosure may include identifying a pattern in HTML code of the webpage 410. The HTML code of the webpage 410 may describe the layout, order, and/or association of the elements of the webpage 410. Identifying a pattern in the HTML code or the CSS may include identifying related elements. The pattern may be identified by comparing text of the HTML code or styles with known patterns or by parsing the HTML code for repeated strings. The comparison and/or the parsing may be relative to HTML tags in the HTML code.

For example, the HTML code for the webpage 410 may include, in order: an image tag (corresponding to the first main photo 420A), a paragraph tag (corresponding to the first text description 430A), a span title tag (corresponding to the first mouse-over text 432A), multiple image tags (corresponding to the first thumbnail photos 440A), a button tag (corresponding to the first action buttons 450A), an image tag (corresponding to the second main photo 420B), a paragraph tag (corresponding to the second text description 430B), a span title tag (corresponding to the second mouse-over text 432B), multiple image tags (corresponding to the second thumbnail photos 440B), a button tag (corresponding to the second action buttons 450B), an image tag (corresponding to the third main photo 420C), a paragraph tag (corresponding to the third text description 430C), a span title tag (corresponding to the third mouse-over text 432C), multiple image tags (corresponding to the third thumbnail photos 440C), and a button tag (corresponding to the third action buttons 450C). The HTML code may include three instances of the pattern: an image tag, a paragraph tag, a span title tag, multiple image tags, and a button tag.

In some embodiments, the systems and methods of the present disclosure may include associating the pattern with a particular product. For example, elements included in a first iteration of the pattern may be associated with a first product. The first product may be designated with a tag derived from a URL. For example, the multi-product page may include links to product detail pages. All or part of the URL of a product detail page may be used as designator for that product. Thus, if the first iteration of the pattern in the HTML code includes a link to a particular product, all or part of the URL of that link may be used to designate the first product. As another example, associating the pattern, or elements in the pattern, with a particular product may be based on images of the product. For example, a first a photo included in a first iteration of the pattern may be the same as or similar to a photo (for example, the main photo) from a product detail page. Identifying the similarity between the first photo in the first iteration of the pattern and the photo on the product detail page may be based on a digital comparison between the digital files of the photos and/or a comparison between the images, for example using image recognition techniques.

In some embodiments, the systems and methods of the present disclosure may include associating elements of the webpage 410 with the first product. For example, all elements in one instance of the code pattern may be associated with the same product. For example, each of the image tag, the paragraph tag, the span title tag, the multiple image tags, and the button tag of the example instance of the code pattern may be associated with the same product.

In some embodiments, the systems and methods of the present disclosure may include associating all interactions with any of the elements that are associated with an individual product with the individual product. Thus, for example, a click on the first main photo 420A may be associated with the first product because the HTML code that included the first main photo 420A was associated with the first instance of the code pattern and the first product.

Modifications, additions, or omissions may be made to the webpage 410 without departing from the scope of the present disclosure. Further, the order of operations may vary according to different implementations.

FIG. 5 is a graph 500 illustrating an example of a correlation between a confidence of an expected sales state of a product and a sales state change of the product, according to at least one embodiment described in the present disclosure. The “confidence ranges,” “number of products that entered state 2,” and divisions of “entered state 2 within 7 days,” “entered state 2 between 8 days and 14 days,” “entered state 2 between 15 days and 21 days,” and “entered state 2 between 22 days and 28 days,” are given as an example. The systems and methods of the present disclosure may be implemented on using any suitable confidence ranges, state, divisions of time etc.

As an example, the graph 500 includes four confidence ranges “0-0.25,” “0.26-0.5,” “0.51-0.75,” and “0.76-1.” Any suitable number and values of ranges may be used. Further, the ranges need not be uniform in size. As an example, the graph 500 includes four divisions of time of “entered state 2 within 7 days,” “entered state 2 between 8 days and 14 days,” “entered state 2 between 15 days and 21 days,” and “entered state 2 between 22 days and 28 days.” Any suitable number and duration of divisions may be used. Further, the divisions need not be uniform in time duration. As an example, the graph 500 is all relative to a transition to state 2. Any suitable state transition may be used.

The graph 500 of FIG. 5 illustrates one way of determining a correlation between confidences and state transitions. The correlation may be used to determine a likelihood that a product with a given confidence enters a particular state within a particular period of time. The graph 500 of FIG. 5 is given and explained to illustrate one way that the likelihood may be determined based on a correlation.

For example, the graph 500 represents a correlation between actual state data (including a duration products remained in states) and confidences associated with the products. For example, the vertical hashing in the first bar from the left may represent a number of products that had a confidence of between 0-0.25 with respect to a second state and remained in the first state for between 15 and 21 days before entering the second state.

Based on the illustrated correlation, a product with a given confidence relative to a transition to the second state, may be given a likelihood prediction relative to a period of time within which the product may transition to the second state. For example, if a product had a confidence of 0.8, it may be given a likelihood prediction based on numbers of products that transitioned to the second state with a confidence of between 0.75 and 1. For example, the likelihood that the product would enter the second state within 7 days may be given by the ratio of products in the confidence range 0.75 to 1 that entered the second state within 7 days divided by the total number of products represented by the graph 500 with a confidence between 0.75 and 1. The ratio may be visualized as the length of the bar on the far right, with the diagonal hashing from bottom left to top right compared to the combined length of the four bars on the far right.

Modifications, additions, or omissions may be made to the graph 500 without departing from the scope of the present disclosure. For example, the ranges of the bars may be adjusted.

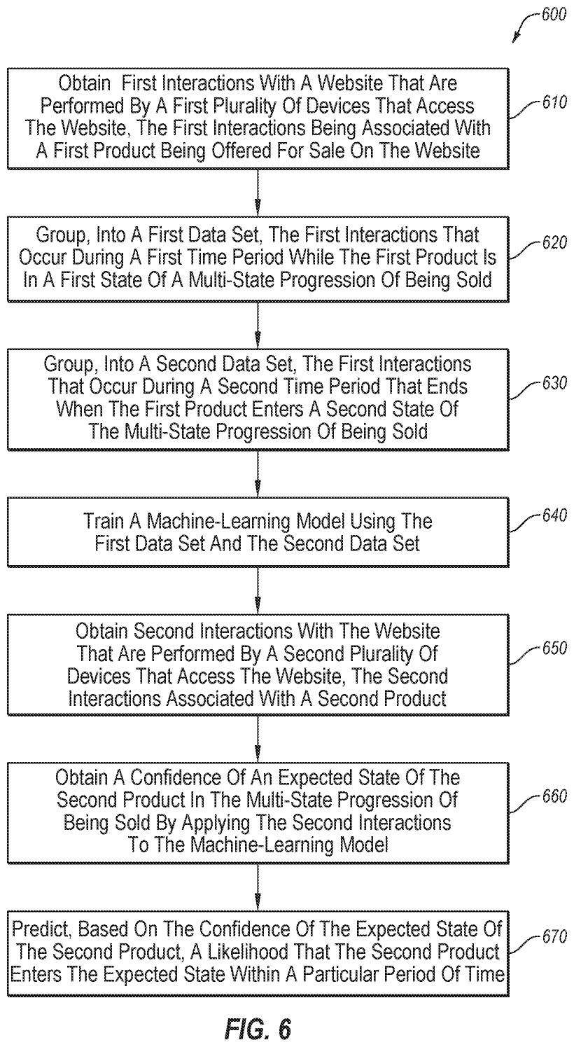

FIG. 6 is a flow chart of an example method 600 to predict a change in the sales state of a product based on interaction data, according to at least one embodiment described in the present disclosure. In some embodiments, one or more of the operations associated with the method 600 may be performed by the environment 100 of FIG. 1 and/or the environment of FIG. 2. The method 600 may be performed by any suitable system, apparatus, or device. For example, the computing system 700 of FIG. 7 may perform or control performance of one or more of the operations associated with the method 600. Although illustrated with discrete blocks, the steps and operations associated with one or more of the blocks of the method 600 may be divided into additional blocks, combined into fewer blocks, or eliminated, depending on the desired implementation.

At block 610 first interactions may be obtained. The first interactions may include interactions with the web site that are performed by a first plurality of devices that access the website. The first interactions may be associated with a first product being offered for sale on the website. In some embodiments, the first product may have entered a second or third state of a multi-state progression of being sold at the time of the execution of the method 600. The website 122 of FIG. 1 may be an example of the website of block 610. The client devices 110 of FIG. 1 may be an example of the first plurality of client devices of block 610.

In some embodiments, the first interactions may include interactions with a listing of a first product for sale. The listing of the first product may be performed by a first plurality of devices through applications on the first plurality of devices. In some embodiments, the first plurality of devices may obtain the information for the listing of the first product to present through the application from a server. In some embodiments, the listing of the first product may be presented by a non-browser application running on the first plurality of devices.

At block 620 the first interactions that occur during a first time period while the first product is in a first state of a multi-state progression of being sold may be grouped into a first data set. For example, the first state of the multi-state progression of being sold may be “for sale.” The first period of time need not be the entire duration of time during which the first product was in the first state.

At block 630 the first interactions that occur during a second time period that ends when the first product enters a second state of the multi-state progression of being sold may be grouped into a second data set. For example, the second state of the multi-state progression of being sold may be “sold” or “under contract.” The second period of time may include, for example, any number of days or hours preceding the transition of the first product from the first state to the second state. In some embodiments, the first and second time periods may overlap. Alternately or additionally, some of the first interactions may be in both the first data set and the second data set.

At block 640 a machine-learning model may be trained using the first data set and the second data set. There may be a feature in the first data set and the second data set indicating whether the first interactions of the first data set and the second data set belong to the first data set or the second data set. For example, the feature in the first data set and the second data set may be a target feature, which may be known in the art as a target variable.

At block 650 second interactions with the website may be obtained. The second interactions may include interactions that are performed by a second plurality of devices that access the website. The second interactions may be associated with a second product. In some embodiments, the second product may be in the first state of the multi-state progression of being sold at the time of the execution of the method 600. The client devices 110 of FIG. 1 may be an example of the second plurality of devices of block 650.

In some embodiments, the second interactions may include interactions with a listing of a second product for sale. The listing of the second product may be performed by a second plurality of devices through applications on the second plurality of devices. In some embodiments, the second plurality of devices may obtain the information for the listing of the second product to present through the application from a server. In some embodiments, the listing of the second product may be presented by a non-browser application running on the second plurality of devices.

At block 660 a confidence of an expected state of the second product in the multi-state progression of being sold may be obtained by using the second interactions with the machine-learning model. For example, the machine-learning model may classify the second product in an expected state based on a similarity between the second interactions and either the first data set or the second data set.

At block 670 a likelihood that the second product enters the expected state within a particular period of time may be predicted based on the confidence of the expected state of the second product. For example, the confidence of the expected state of the second product may be correlated with a likelihood that the second product enters the expected state within the period of time.

Modifications, additions, or omissions may be made to the method 600 without departing from the scope of the present disclosure. Further, the order of operations may vary according to different implementations. For example, block 620 and block 630 may occur at the same time or as part of the same step. As another example, the block 610 may occur at the same time as the block 650.

For example, the multi-state progression of being sold may include two states. The first product being in the first state of the multi-state progression may indicate that the first product is unsold and the first product being in the second state of the multi-state progression may indicate that the first product is sold.

Additionally or alternatively, the multi-state progression of being sold may include three or more states. For example, the first product being in the first state of the multi-state progression may indicate that the first product is unsold, the first product being in the second state of the multi-state progression may indicate that the first product is in an intermediate state between unsold and sold, for example, subject to an agreement to be sold, and the first product being in the third state of the multi-state progression may indicate that the first product is sold. In these or other embodiments, the expected state may be the second state or the third state.

As another example, the method 600 may further include grouping, into a third data set, the first interactions associated with the first product that occur during a third time period that ends when the first product enters a third state of the multi-state progression of being sold. The machine-learning model may be trained using the first data set, the second data set, and the third data set.

As another example, the website may include a first webpage that includes information about the first product and a second webpage that includes information about the first product. A first subset of the first interactions may be performed with respect to the first webpage and a second subset of the first interactions may be performed with respect to the second webpage. In these or other embodiments, the first webpage may include information about multiple products that are listed for sale on the website, including the first product.

As another example, in an instance where the website includes a multi-product webpage that includes information about multiple products, including the first product, the method 600 may further include identifying a pattern in HTML code or CSS of the multi-product webpage. The method 600 may further include associating the pattern with the first product. The method 600 may further include associating an element of the multi-product webpage with the first product based on the association between the pattern and the first product. The method 600 may further include associating the first interactions with the first product based on the first interactions interacting with the first element.

As another example, the method 600 may further include obtaining a correlation between a confidence of the expected state of a third product being listed for sale on the website from the machine learning model and the third product entering the expected state within the particular period of time. The method 600 may further include predicting the likelihood that the second product enters the expected state within the particular period of time based on the correlation and the confidence of the expected state of the second product.

As another example, the method 600 may include obtaining third interactions with the web site that are performed by a third plurality of devices that access the web site, the third interactions associated with a third product. The method 600 may further include obtaining a second confidence of an expected state of the third product in the multi-state progression by using the third interactions with the machine-learning model. The method 600 may further include obtaining a correlation between the second confidence of the expected state of the third product and the third product entering the expected state within the particular period of time. In these or other instances, predicting the likelihood that the second product enters the expected state within the particular period of time may be based on the correlation and the confidence of the expected state of the second product.

As another example, one or more of the first plurality of devices may be the same devices as one or more of the second plurality of devices.

One skilled in the art will appreciate that, for the environment 100 of FIG. 1, the environment 200 of FIG. 2, and the method 600 and other processes and methods disclosed herein, the functions performed in the processes and methods may be implemented in differing order. Furthermore, the outlined steps and actions are only provided as examples, and some of the steps and actions may be optional, combined into fewer steps and actions, or expanded into additional steps and actions without detracting from the essence of the disclosed embodiments.

FIG. 7 is a block diagram of an example computing system, 700, which may be according to at least one embodiment described in the present disclosure. As illustrated in FIG. 7, the computing system 700 may include a processor 702, a memory 704, a data storage 706, and a communication unit 708.

Generally, the processor 702 may include any suitable special-purpose or general-purpose computer, computing entity, or processing device including various computer hardware or software modules and may be configured to execute instructions stored on any applicable computer-readable storage media. For example, the processor 702 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 7, it is understood that the processor 702 may include any number of processors distributed across any number of network or physical locations that are configured to perform individually or collectively any number of operations described herein. In some embodiments, the processor 702 may interpret and/or execute program instructions and/or process data stored in the memory 704, the data storage 706, or the memory 704 and the data storage 706. In some embodiments, the processor may fetch program instructions from the data storage 706 and load the program instructions in the memory 704. After the program instructions are loaded into the memory 704, the processor 702 may execute the program instructions, such as instructions to perform one or more operations described with respect to the client devices 110, the server 120, and/or the system 130 of FIG. 1 and/or the environment 200 of FIG. 2.

The memory 704 and the data storage 706 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 702. By way of example, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 702 to perform a certain operation or group of operations. In these and other embodiments, the term “non-transitory” as explained herein should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 708 may be configured to receive communications, including interaction data and to provide the communications to the data storage 706.. The communication unit 708 may include any device, system, component, or collection of components configured to allow or facilitate communication between the computing system 700 and a network. For example, the communication unit 708 may include, a modem, a network card (wireless or wired), an infrared communication device, an optical communication device, a wireless communication device (such as an antenna), and/or chipset (such as a Bluetooth device, an 802.6 device (e.g. Metropolitan Area Network (MAN)), a Wi-Fi device, a WiMAX device, cellular communication facilities, etc.), and/or the like. The communication unit 708 may permit data to be exchanged with any network such as a cellular network, a Wi-Fi network, a MAN, an optical network, etc., to name a few examples, and/or any other devices described in the present disclosure, including remote devices.

Modifications, additions, or omissions may be made to the computing system 700 without departing from the scope of the present disclosure. For example, the data storage 706 may be located in multiple locations and accessed by the processor 702 through a network.

As used herein, the terms “module” or “component” may refer to specific hardware implementations configured to perform the operations of the module or component and/or software objects or software routines that may be stored on and/or executed by general-purpose hardware (e.g., computer-readable media, processing devices, etc.) of the computing system. In some embodiments, the different components, modules, engines, and services described herein may be implemented as objects or processes that execute on the computing system (e.g., as separate threads).

While some of the system and methods described herein are generally described as being implemented in software (stored on and/or executed by general-purpose hardware), specific hardware implementations or a combination of software and specific hardware implementations are also possible and contemplated. In the present disclosure, a “computing entity” may be any computing system as previously defined herein, or any module or combination of modulates running on a computing system.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.” Additionally, use of the term “and/or” in some places does not mean that the term “or” should be understood to only include either of the terms as opposed to including the possibility of both terms.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
obtaining first interactions with a website that are performed by a first plurality of devices that access the website, the first interactions being associated with a first product listed for sale on the website;
grouping, into a first data set, the first interactions that occur during a first time period while the first product is in a first state of a multi-state progression of being sold;
grouping, into a second data set, the first interactions that occur during a second time period that ends when the first product enters a second state of the multi-state progression of being sold;
training a machine-learning model using the first data set and the second data set;
obtaining second interactions with the web site that are performed by a second plurality of devices that access the website, the second interactions associated with a second product;
obtaining a confidence of an expected state of the second product in the multi-state progression of being sold by using the second interactions with the machine-learning model; and
predicting, based on the confidence of the expected state of the second product, a likelihood that the second product enters the expected state within a particular period of time.

2. The method of claim 1, wherein the multi-state progression of being sold includes two states, wherein the first product being in the first state of the multi-state progression indicates the first product is unsold and the first product being in the second state of the multi-state progression indicates the first product is sold.

3. The method of claim 1, further comprising grouping, into a third data set, the first interactions associated with the first product that occur during a third time period that ends when the first product enters a third state of the multi-state progression of being sold, wherein the machine-learning model is trained using the first data set, the second data set, and the third data set.

4. The method of claim 3, wherein the expected state is the second state or the third state.

5. The method of claim 3, wherein the first product being in the first state of the multi-state progression indicates the first product is unsold, the first product being in the second state of the multi-state progression indicates the first product is in an intermediate state between unsold and sold, and the first product being in the third state of the multi-state progression indicates the first product is sold.

6. The method of claim 1, wherein the website includes a first webpage that includes information about the first product and a second webpage that includes information about the first product, a first subset of the first interactions are performed with respect to the first webpage and a second subset of the first interactions are performed with respect to the second webpage.

7. The method of claim 6, wherein the first webpage includes information about multiple products that are listed for sale on the website, including the first product.

8. The method of claim 1, wherein the website includes a multi-product webpage that includes information about multiple products, including the first product, the method further comprising:
identifying a pattern in Hypertext Markup Language (HTML) code or Cascading Style Sheet (CS S) of the multi-product webpage;
associating the pattern with the first product;
associating an element of the multi-product webpage with the first product based on the association between the pattern and the first product; and
associating the first interactions with the first product based on the first interactions interacting with the first element.

9. The method of claim 1, wherein predicting the likelihood comprises obtaining a correlation between a confidence of the expected state of a third product being listed for sale on the website from the machine learning model and the third product entering the expected state within the particular period of time,
wherein the predicting the likelihood that the second product enters the expected state within the particular period of time is based on the correlation and the confidence of the expected state of the second product.

10. The method of claim 1, wherein predicting the likelihood comprises:
obtaining third interactions with the website that are performed by a third plurality of devices that access the website, the third interactions associated with a third product;
obtaining a second confidence of an expected state of the third product in the multi-state progression by using the third interactions with the machine-learning model;
obtaining a correlation between the second confidence of the expected state of the third product and the third product entering the expected state within the particular period of time,
wherein the predicting the likelihood that the second product enters the expected state within the particular period of time is based on the correlation and the confidence of the expected state of the second product.

11. The method of claim 1, wherein one or more of the first plurality of devices are the same devices as one or more of the second plurality of devices.

12. A system comprising:
at least one non-transitory computer-readable media configured to store one or more instructions; and
at least one processor coupled to the at least one non-transitory computer-readable media, the at least one processor configured to execute the instructions to cause or direct the system to perform operations, the operations comprising:
obtaining first interactions with a listing of a first product for sale that are performed by a first plurality of devices that present the listing of the first product;
grouping, into a first data set, the first interactions that occur during a first time period while the first product is in a first state of a multi-state progression of being sold;
grouping, into a second data set, the first interactions that occur during a second time period that ends when the first product enters a second state of the multi-state progression of being sold;
training a machine-learning model using the first data set and the second data set;
obtaining second interactions with a listing of a second product for sale that are performed by a second plurality of devices that present the listing of the second product;
obtaining a confidence of an expected state of the second product in the multi-state progression of being sold by using the second interactions with the machine-learning model; and
predicting, based on the confidence of the expected state of the second product, a likelihood that the second product enters the expected state within a particular period of time.

13. The system of claim 12, wherein the multi-state progression of being sold includes two states, wherein the first product being in the first state of the multi-state progression indicates the first product is unsold and the first product being in the second state of the multi-state progression indicates the first product is sold.

14. The system of claim 12, the operations further comprising grouping, into a third data set, the first interactions associated with the first product that occur during a third time period that ends when the first product enters a third state of the multi-state progression of being sold, wherein the machine-learning model is trained using the first data set, the second data set, and the third data set.

15. The system of claim 14, wherein the expected state is the second state or the third state.

16. The system of claim 14, wherein the first product being in the first state of the multi-state progression indicates the first product is unsold, the first product being in the second state of the multi-state progression indicates the first product is in an intermediate state between unsold and sold, and the first product being in the third state of the multi-state progression indicates the first product is sold.

17. The system of claim 12, wherein the listing of the first product is part of a website, wherein the website includes a first webpage that includes information about the first product and a second webpage that includes information about the first product, a first subset of the first interactions are performed with respect to the first webpage and a second subset of the first interactions are performed with respect to the second webpage.

18. The system of claim 12, wherein the listing of the first product is presented by a non-browser application running on the first plurality of devices.

19. The method of claim 1, wherein predicting the likelihood comprises obtaining a correlation between a confidence of the expected state of a third product being listed for sale on the website from the machine learning model and the third product entering the expected state within the particular period of time,
wherein the predicting the likelihood that the second product enters the expected state within the particular period of time is based on the correlation and the confidence of the expected state of the second product.

20. A method comprising:
obtaining first interactions with a first webpage of a website that are performed by a first plurality of devices that access the website, the first webpage including information about a first product listed for sale on the website;
obtaining second interactions with a second webpage of the website that are performed by a second plurality of devices that access the website, the second webpage including information about the first product and a second product that is listed for sale on the website;
analyzing the second webpage to identify an element of the second webpage that is associated with the first product;
associating a subset of the second interactions with the first product based on the subset of the second interactions interacting with the identified element of the second webpage;
grouping, into a first data set, interactions from the first interactions and the subset of the second interactions that occur during a first time period while the first product is in a first state of a multi-state progression of being sold;
grouping, into a second data set, the interactions from the first interactions and the subset of the second interactions that occur during a second time period that ends when the first product enters a second state of the multi-state progression of being sold;
training a machine-learning model using the first data set and the second data set;
obtaining third interactions with the web site that are performed by a third plurality of devices that access the website, the third interactions associated with a third product that is listed for sale on the website;
obtaining a first confidence of the third product entering the second state by using the third interactions with the machine-learning model;
obtaining a correlation between a first confidence of the third product and the third product entering the second state within a particular period of time;
obtaining fourth interactions with the website that are performed by a fourth plurality of devices that access the website, the fourth interactions associated with a fourth product that is listed for sale on the website;
obtaining a second confidence of the fourth product entering the second state by using the fourth interactions with the machine-learning model; and
predicting, based on the second confidence and the correlation, a first likelihood that the fourth product enters the second state within the particular period of time.
